(19) United States
(12) Patent Application Publication
(10) Pub. No.: US 2011/0145065 A1
(43) Pub. Date: Jun. 16, 2011

(54) CONSUMER TARGETED ADVERTISING THROUGH NETWORK INFRASTRUCTURE

(76) Inventor: Shakeel MUSTAFA, Fremont, CA (US)

(21) Appl. No.: 12/963,354

(22) Filed: Dec. 8, 2010

Related U.S. Application Data
(60) Provisional application No. 61/283,852, filed on Dec. 10, 2009.

(51) Int. Cl. G06Q 30/00

(52) U.S. Cl. 705/14.53; 705/14.57; 705/14.66

(57) ABSTRACT

In one embodiment, a method for determining a consumer's interest in products and services is disclosed. Once the consumer's interests are determined advertisers can refine their advertisements to meet the consumer's specific needs and demands. A method for providing targeted information begins by receiving data comprising at least one of a consumer's product or service interests. The data is inspected to determine at least one consumer product or service interest. The at least one determined product or service interest is compared with a plurality of providers of products or services. Finally information is conveyed to the consumer from to at least one of the plurality of providers of products or services to the consumer based upon the comparison of the determined at least one product or service interest and the plurality of providers of products or services.

### CLAIM OF PRIORITY

This application claims priority to U.S. Provisional Application No. 61/283,852, filed Dec. 10, 2009, the disclosure of which is thereby incorporated by reference.

### FIELD OF TECHNOLOGY

This disclosure relates generally to communication systems, methods, and devices for delivering customized advertisements specifically tailored to an individual consumer's needs through multimedia delivery services.

### BACKGROUND

There is huge expenditure on advertising worldwide every year. A major problem in the current advertising model is to precisely identify the targeted consumers who will have a higher probability of buying advertised products and services than just reaching out to general consumers. Companies have tried different methods which mainly consist of consumers' surveys to determine the interest level of the consumers in their advertised products. The majority of the time these surveys tend to be intrusive and consumers either don't respond very well or are unwilling to participate in these surveys.

The present invention uses an enhanced approach. It utilizes methods that observe the behavioral pattern of the consumers without being intrusive while requiring minimum efforts from the consumers in order to identify their needs. Based on consumers' specific needs and preferences the present invention illustrates different methods to advertise different products and services specifically targeting and meeting consumers' criterion. The present invention uses multimedia technologies to selectively transmit customized advertisements to the specific consumers thus promising much higher responses from the consumers.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present invention utilizes methods that determine consumer interests with minimum consumer involvement. In one embodiment, consumers' interests are determined from their purchasing habits and preferences. For example, when a consumer makes a purchase, all data related to consumer items are saved into a database under his/her account. From the consumers' successive buying behaviors consumers' buying profiles are built. These profiles are built for every individual consumer. Based on the consumer's profile, simple or complex methods of extrapolations, e.g., polynomial extrapolation, conic extrapolation, french curve extrapolation, etc. can be developed to predict the consumer's future buying behavior along with a preferred way of communicating to the individual consumer. These extrapolations can be used to predict an individual consumer's future interests in buying different products. Based on these predictions customized advertisements can be produced and send to the individual consumers.

In addition, consumer preferences to certain geographical locations represented through a coordinate system, e.g., GPS (Global Positioning System) coordinates can also be utilized. The product and services that a consumer has identified as having an interest in are compared to products and services broadcasted by different vendors located at different locations. The best match between the consumer's preferences including distances to the locations and the available product and services are determined and the consumer is informed.

### BRIEF DESCRIPTION OF THE DRAWINGS

Example embodiments are illustrated by way of example and not limitation in the figures of the accompanying drawings, in which like references indicate similar elements and in which:

FIG. 1 is a diagram of an exemplary communication system for delivering the information details of the items bought by consumers to Storage Data Servers.

FIG. 2 is a block diagram of an exemplary storage system where the information belonging to different items is stored under individual consumers' accounts.

FIG. 3 is a block diagram illustrating an exemplary method for capturing transmitted information to identify consumer's interests.

FIG. 4 is a process flow chart of an exemplary method for transmitting consumer related information through different media types.

FIG. 5 is a process flow chart of an exemplary method for collecting consumers' interests by inspecting consumer data.

FIG. 6 is a block diagram illustrating an exemplary process for collecting consumers' interests and then populating the consumers' interests in the database servers.

FIG. 7 is a block diagram illustrating an exemplary network system collecting the information from different systems for comparison.

FIG. 8 is a block diagram illustrating methods for comparison of the consumers' interests gathered from different processes.

FIG. 9 is a block diagram illustrating availability of different products and services at different geographical locations.

FIG. 10 is a block diagram illustrating different people engagements based on their mutual distances and preferences and the notification methods based on different geographical locations.

Other features of the present embodiments will be apparent from the accompanying drawings and from the detailed description that follows.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations for fabricating semiconductor devices. These descriptions and representations are the means used by those skilled in the art of semiconductor device fabrication to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities.

An embodiment described in the detailed description is directed towards methods used for customized advertising specifically targeted to individual consumers. In the current advertisement methods it is very rare to seek consumers' interests before advertisements are projected to the consumers. Since the interest level of consumers is not known ahead of time such general types of advertisements can be ineffective. This results in an inefficient use of advertising money spent on advertisements. Even when consumers' interest level is determined beforehand, it is commonly determined through intrusive methods that consumers generally don't like. For example, the methods may involve asking the consumers to complete the surveys, fill out web-forms or through consumer interviews.

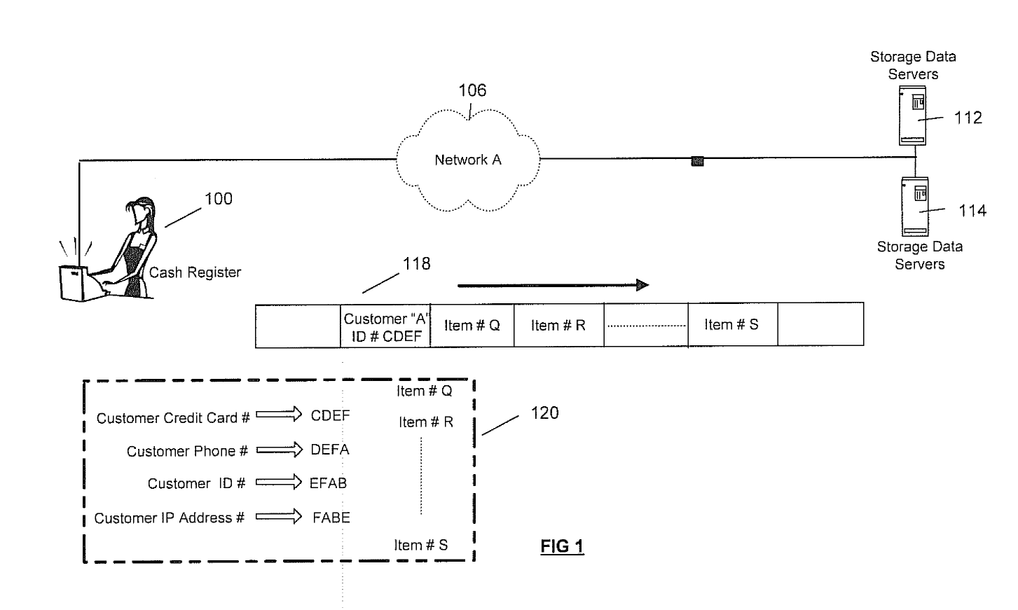

FIG. 1 shows a consumer service person 100 who is operating a cash register and scanning items that a consumer has purchased. When a consumer gives his credit card information or telephone number and any other piece of identification that can uniquely identify him, all of the consumer's personal history comes up as shown in the table 120. All the information related to consumer purchased items is transmitted through an exemplary packet format 118. Packet format 118 can carry consumers' identification, the characteristics of the items, e.g., item number, quantity, price paid, coupons used, etc., that the consumer “A” has bought. All this information is transmitted to Storage Data Servers, 112, 114 across the network 106.

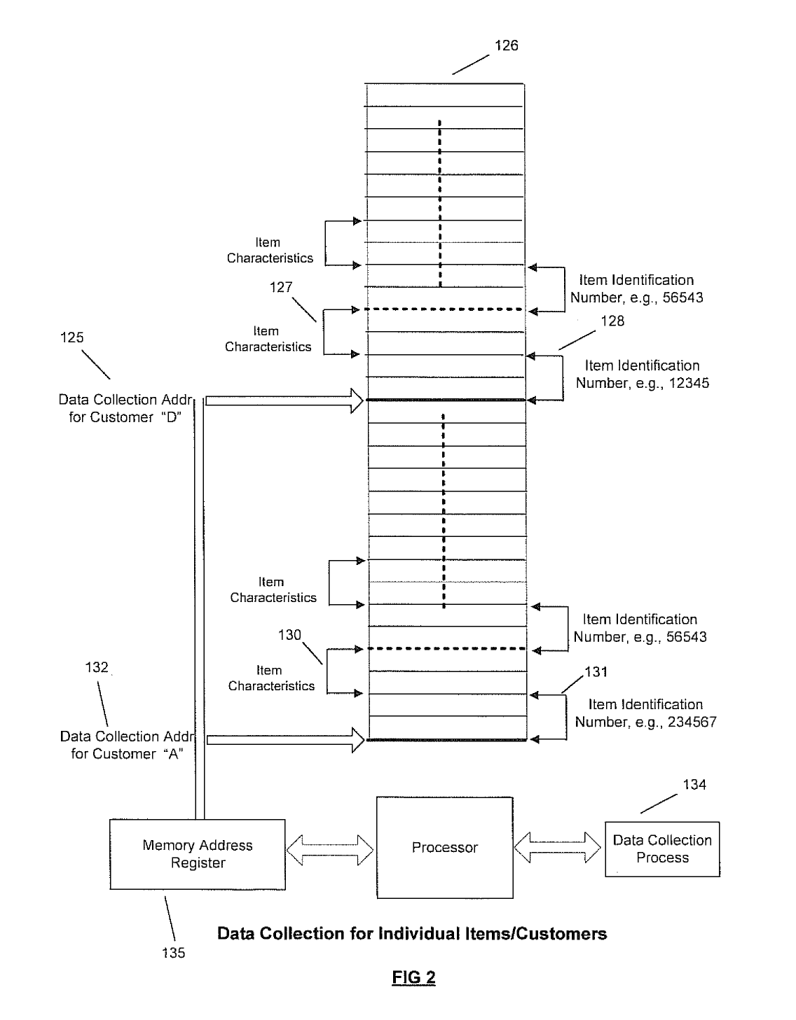

FIG. 2 shows an exemplary method of identifying the information transmitted using the data packets 118. Data Collection Process 134 identifies the consumer ID # and the information about the items that the consumer bought and their relevant characteristics. The consumer unique ID # is fed to the Memory Address Register 135. The Memory Address Register uses the consumer ID # as a pure binary number and access the corresponding memory block location in the memory array 132. In the first sub-block 131 the identification number, e.g., 234567 is stored. In the following sub-block 130, all the characteristics belonging to that specific item are stored. In a similar fashion all the items bought by consumer “A” are stored along with their characteristics. Similarly, for another consumer “D,” Data Collection Address 125 is processed by the Memory Address Register 135 such that all the information about the items purchased by Consumer D are kept in the memory sub-blocks with item identification numbers in sub-block 128 and the corresponding item characteristics in sub-block 127. A processor can be used to parse all the items and identify the consumers who bought these items. This information can be used to extrapolate the purchasing behavior of the individual consumers.

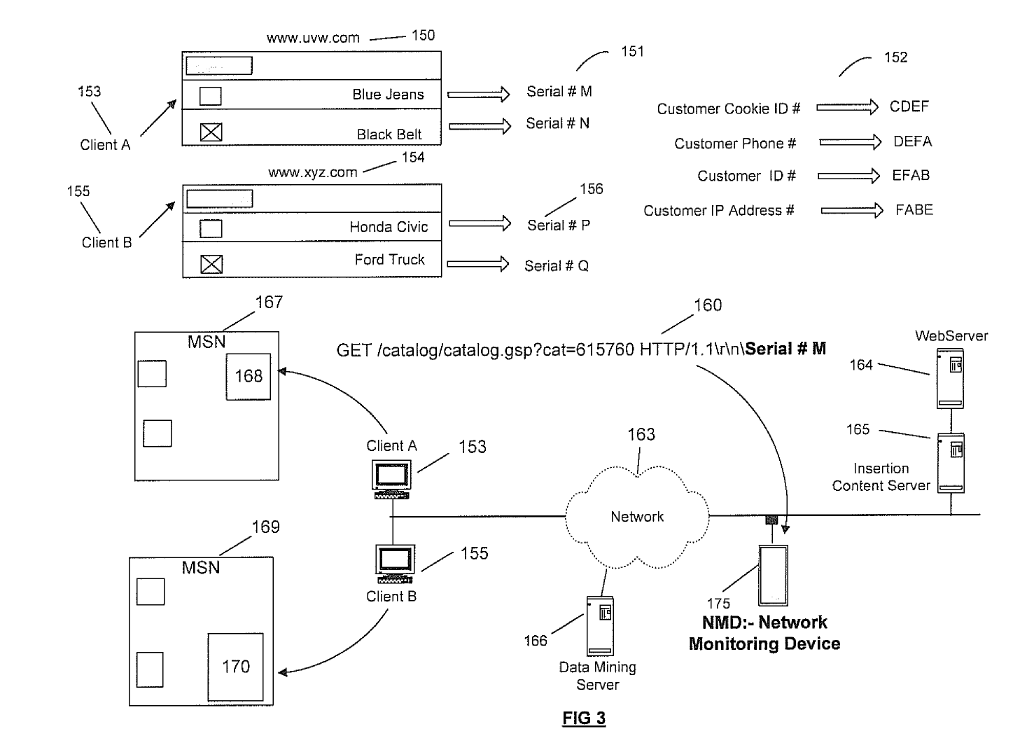

FIG. 3 shows an exemplary method and system for capturing details for items that a consumer finds interesting as he browses through different websites. As shown in FIG. 3 a Client “A” 153 browses the Internet and exchanges his data traffic over the network 163 to reach to a webserver 164. For example, the Client browses a website, e.g., www.uvw.com, 150 hosted by the WebServer 164. The Client “A” 153 browses through some of the webpages containing information about interested items, e.g., Blue Jeans, Black Belt, etc. Each of these webpages utilizes item numbers locally used by the web service to identify the items. For example, the Serial # M, 151, can represent a unique ID tag used by the webpage when displaying information about a particular pair of blue jeans. As the Client “A” navigates through different information embedded in the webpages hosted by the website, www.uvw.com, 150 on the webserver 164 all traffic pattern exchanges taking place between the Client “A” 161 and the webserver 164 are captured by a Networking Monitoring Device, (NMS), 175. The NMS 175 can be a protocol analyzer that can probe into the contents carried by a higher application layer of the data packets.

As an example, the contents of the higher application layer can be revealed by capturing the contents of a GET command. A GET command works with FTP (File Transfer Protocol) which directs the webserver to transmit the data information. If the Client “A”, 153 is accessing information about an “item #M”, a typical GET syntax 160 will be captured by the Network Monitoring Device 175. The information captured by the NMD 170 is transmitted to a Data Mining Server 156. The Data Mining Server identifies the item(s) that Client “A” 153 has been browsing or has expressed interest in. It searches for corresponding advertisements through any sources available to it. If desired, it can even change the format of the advertisements. It then forwards its contents with desirable formats to the Insertion Content Server, 165. Therefore, the next time the Client “A” 153 accesses a webpage hosted by the webserver 164 the Insertion Content Server 165 will insert advertisement in the appropriate places already indentified to carry advertisements in the webpage. These advertisements will be specific to the Client “A” 153 interests that was determined through the data mining of the data transmitted or received by the said client. For example, if the Client “A”, 153, has browsed or expressed interest in “Blue Jeans,” item # M, 151, all the advertisements that the Data Mining Server 166 could identify as relevant to item # M will be inserted into proper places within webpages by the Insertion Content Server 165. The customized webpage that the Client “A” 153 will access from the Webserver 164 will contain the advertisements relating to “Blue Jeans” or items relating to clothing. The Client “A”, 153 will see a webpage, for example, an MSN home page with the customized advertisement displayed in the specific webpage location 168.

Similarly, another Client “B” 155 accesses the Webserver and browses through pages or expresses interest in the webpages of website www.xyz.com, 154 hosting the information related to automobiles. Those items identified as Serial # P, 156, for example, are captured by the Networking Monitoring Device, NMD, 175 when Client “B” expresses interest in a particular automobile. This information is sent to the Data Mining Server 166 which searches and identifies relevant advertisements related to auto mobiles. The customized advertisements are sent to the Insertion Content Server, 165. If the Client “B” 155 happens to access his homepage hosted by Microsoft Network (MSN) hosted by the Webserver 164, the Insertion Content Server 165 inserts the customized advertisements related to automobiles into the web pages at the appropriate places. As a result, the Client “B” 155 will now see a MSN homepage 169 which contains the advertisement related to automobiles at the webpage location 170.

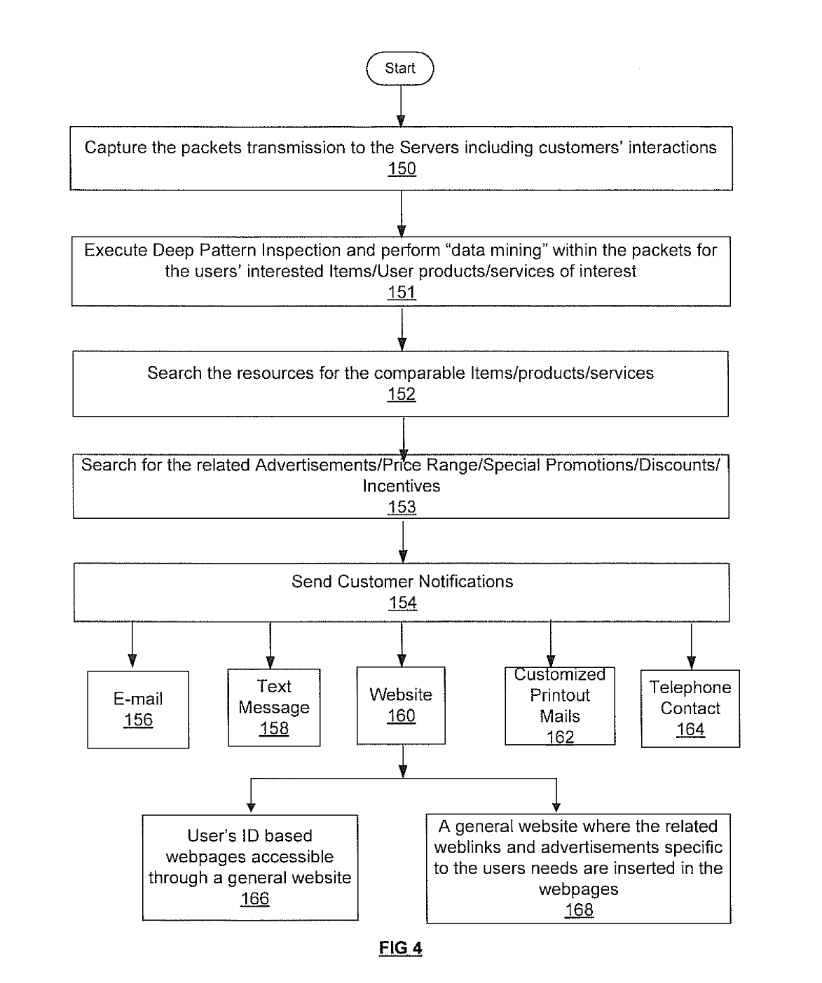

FIG. 4 illustrates a Flowchart describing the steps to communicate information with potential consumers. In step 150, a device captures a transmission between servers and individual consumers. In Step 151, the device performs a deep execution pattern inspection and performs data mining into a data portion where it would carry the information about the potential interest that the consumer has in products and services. In step 152, the process searches for all the available information sources for comparable products and services. In step 152, the process also finds an advertisements/price range, etc, and other information that the consumer would be interested in. Once identified, the process sends the consumer notifications through different methods in step 154. For example, these notifications can be sent by email 156, text message 158 website 160, customized printout mails 162, via telephone contacts to the consumers, etc. There are multiple ways that can be used over websites to distribute consumers' interests. In one aspect, this information can be conveyed through specific websites to the consumer once he identifies himself. Yet in another embodiment, as illustrated in 168, and explained in FIG. 3, a server can use this information and insert the advertisements pertaining to the individual consumers interests in the specific places within the webpages which are reserved for carrying advertisements to the end consumers. These advertisements at specific places in the webpages don't need to be only text based information but can contain any type of multimedia information. For example, as illustrated in FIG. 3, the webpage 169 can contain a text based advertisement, a voice or a video information related to automobiles in which client “B” 155 has expressed an interest.

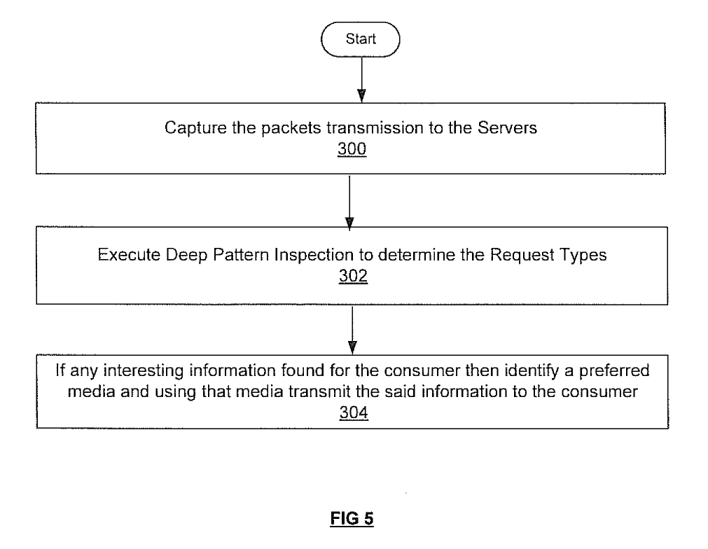

FIG. 5 illustrates a Flowchart which summarizes the presented method. In step 300, the processor captures the packets transmitted to the servers. In step 302, the processor executes a deep pattern inspection of the contents of the packets to determine what information a consumer is interested in. The captured information can reveal the potential consumer's interests. In step 304, the processor selects a media through which the said information can be conveyed to the consumers.

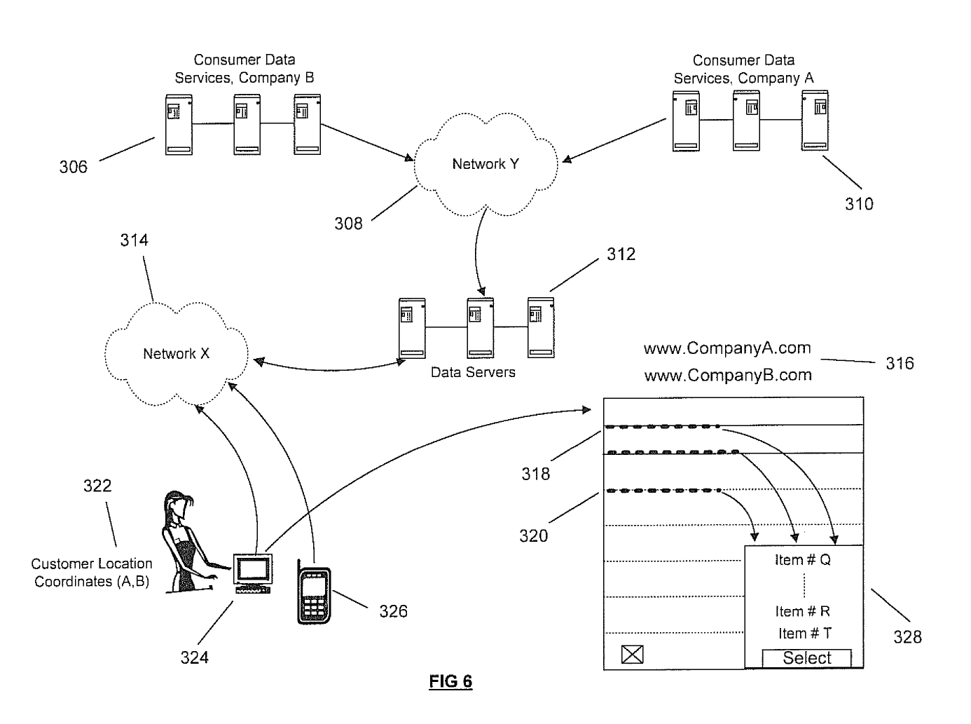

FIG. 6 illustrates a consumer 321 who is searching for different shopping items. The consumer 321 searches for the items at different websites. As she selects an item she populates a personal widget with the item information. The widget is used as a storage means for the consumer to add into her shopping lists. As an example, the consumer 321 browses www.CompanyA.com and www.CompanyB.com 316. The consumer 321 can use her computer 324 or a mobile enabled device 326 to browse different websites. She selects different links 318 and 320, for example, and adds the corresponding items, item #Q, R, T and so on into the widget 328. The widget interactively verifies the integrity and the proper format of the added items. The widget transmits all of the information stored in it using a reliable communication method, e.g., IP/TCP to the data server 312. In addition, the process installed on the consumer's computer and mobile device can transmit the default Global Positioning Coordinates (GPS) linked to the consumer's geographical position. If the consumer prefers, the consumer can overwrite default GPS coordinates with current location coordinates. All the selected items that the consumer has shown an interest in and preferences about acquiring these items, along with GPS coordinates, are transmitted to the Data Servers 312 over the transient network “X” 314. The transient network can be a land line network or a wireless network.

The Data Servers 312 parse the consumer's 321 items list. The Data Server 361 receives the Consumer Data Services Feed from different companies. For example, Company “A” 310 sends information for its entire inventory, such as items available, their regular and discounted prices, along with any other characteristics, to the Data Servers 312 over the Network “Y” 308. In a similar way, other companies, for example, Company “B” 306 also transmits their list of inventories to the Data Servers 312. In another embodiment, the Data Server 312 can probe each of the Companies when it receives consumer requests searching for different items meeting their purchasing criteria. In response to the said requests, the Companies send item availability, prices, and any other useful information to the data server 312. In addition, each of the Companies provides the Data Servers 361 with locations which are near to the consumer's default location or the consumer's preferred locations. This information is provided to the Data Servers 312 by sending the GPS coordinates of respective Stores that the Companies have nearby to the consumer's locations. In addition, the Data Servers 312 can also identify any condition and preferences that the consumer 321 has fed for the items the consumer 321 intends to purchase. For example, these preferences can be days of the week, particular timeslots, and a triggered or preferred price. The Data Servers 312 perform all the necessary searches to identify the items that the consumer has a desire to buy.

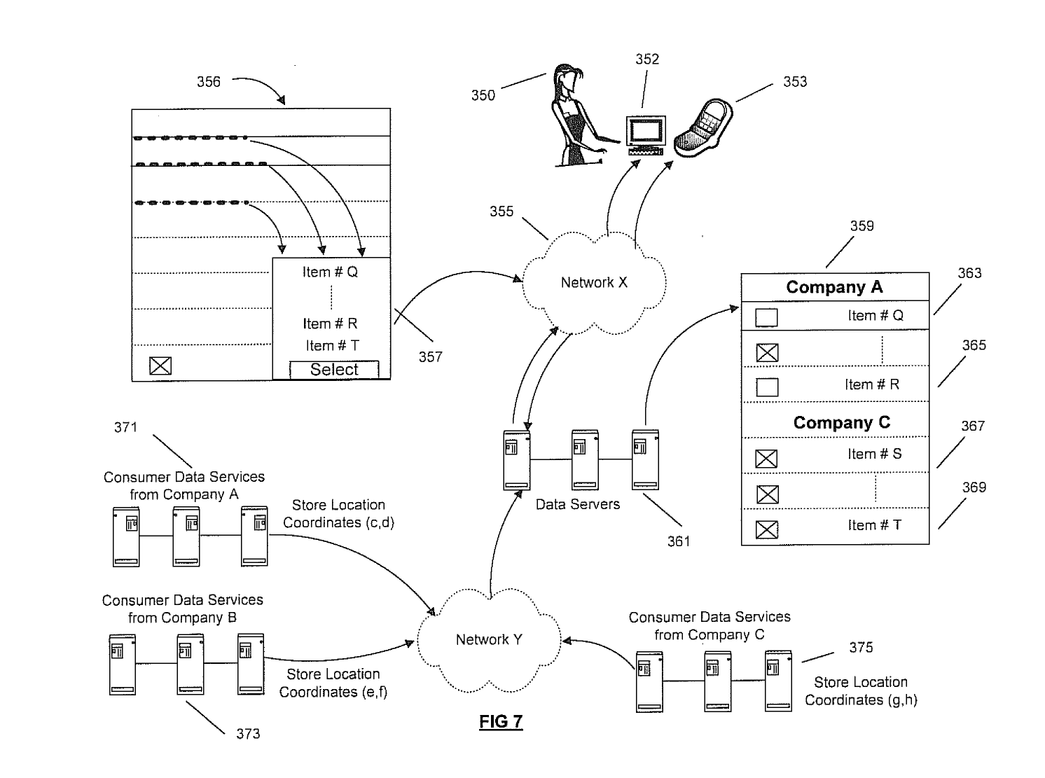

FIG. 7 illustrates the continuation of the method and systems explained with reference to FIG. 6. As illustrated, all the items that consumer 321 has expressed interest in are sent to the Data Servers 361. The Data Servers 361 can either probe the Consumer Data Services for Company “A”, 371, Company “B” 373, Company “C” 375 to get the updates of the requested items or the Consumer Data Server can download all the items that said companies carry in their inventories. As mentioned earlier the companies also provide information related to geographical coordinate locations of their stores through GPS or by other means, e.g., maps, etc. The Data Server 361 receives the Consumer Data Services Feed from different companies. For example, Company “A” 371 sends its entire inventory contents, such as items available, and their regular and discounted prices to the Data Servers 361 over the Network. In a similar way, other companies, for example, Company “B” 373 and Company “C” 375 also transmit their list of inventories to the Data Servers 361. In another embodiment, the Data Server 361 can probe each of the Companies when it receives the consumer requests searching for different items to fulfill his shopping needs. In response to the said requests, the companies send the item availability, prices, and any other useful information to the data server 361.

The Data Server 361 performs an analysis of consumer 321 requests and matches the items meeting the consumer acceptance criteria. For example, if the consumer has asked for the best price for the requested items available in the weekend within certain geographical parameters, then the Data Servers 361 search for the best match out of all the information received through the companies. At a pre-scheduled time, the said Data Servers 361 delivers the itemized list 359 to the consumer 321. The itemized list 359 can contain each of the consumer requested items from different companies. For example, all the matching items found through the Company “A” 359, containing item # “Q” 363, item # “R”, etc. The itemized list will also include all the characteristics information about the individual items. Similarly, the items from Company C will be included.

The Data Servers 361 also calculate the geographical coordinates of each of the stores belonging to different companies and match with the consumer default or preferred coordinates. The itemized list can be transmitted to the consumer 350 by any requested format, e.g., HTML, text, etc. In addition, this list can be transmitted to one or multiple devices in which the consumer has expressed interest. For example, the consumer can receive this information on a PC 352 or on a mobile device 353. In addition, the said information can be provided to the consumer in multiple formats as shown in FIG. 4.

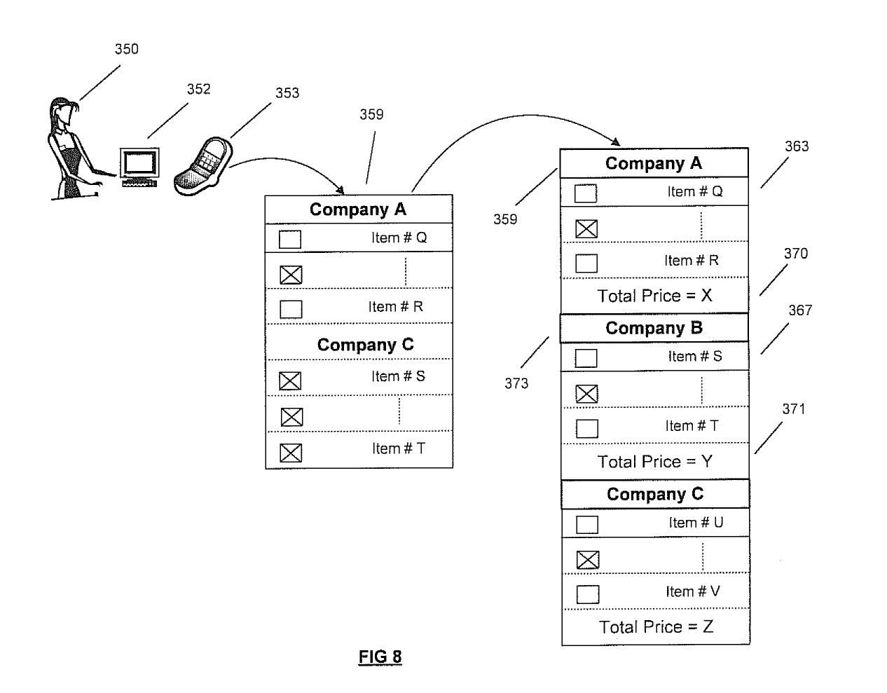

FIG. 8 illustrates a process through which consumer 350 can further receive more refined information about the items the consumer 350 is interested in. For example, the consumer 350 can use a personnel computer (PC) 352 or a mobile Device 353 to request more information from different Companies carrying interested items of the consumer's choice. The consumer 350 can initiate the process and further request the Data Server 361 to provide the consumer 350 with the entire items list for comparing Company “A” 359, Company “B” 370 and Company “C” 377. For example, the Company “A” 359 sends all the items, e.g., item # “Q” 363 and other items with their total price 370. Similarly, the Company “B” 373 reports all the items, e.g., item # S 367 and other items the Consumer 350 has expressed interest, and reporting the total price 371. This provides the consumer 350 with a very powerful tool to get the information about the price comparison through all the Companies, e.g., receiving a price list from Company “A” 359, a price list from Company “B” 373, and a price list from Company “C” 375.

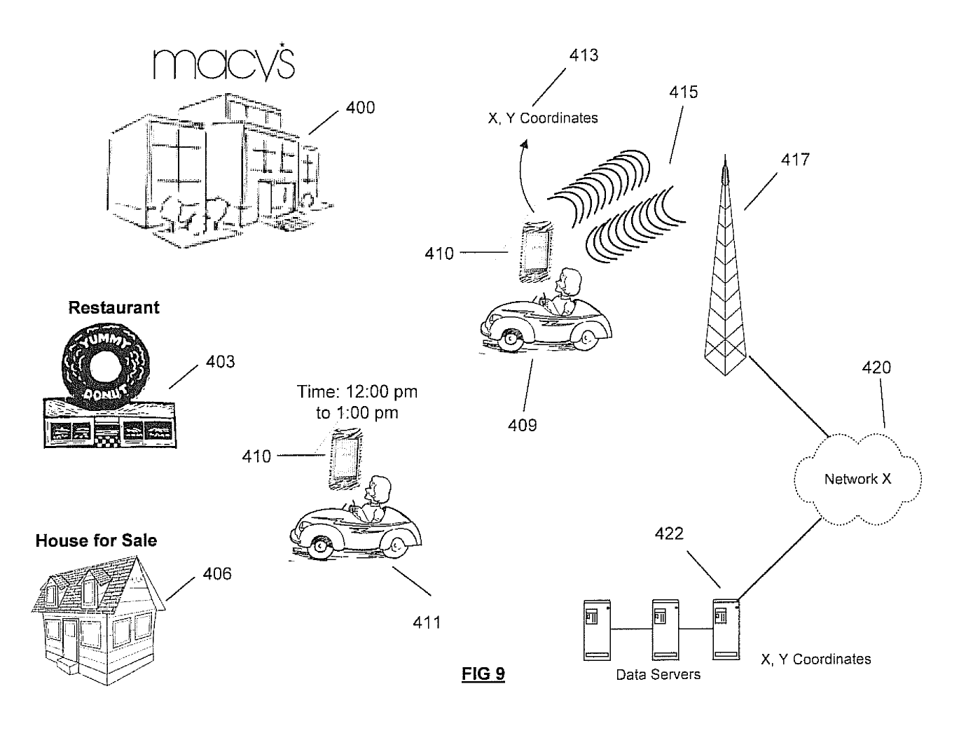

FIG. 9 illustrates a method that consumers can use to facilitate and enhance their shopping experience. As explained in FIG. 6, the Consumer 321 has previously selected different items of interest. The list of interested items for the Consumer 321 is stored in the Data Servers 312. FIG. 9 shows the consumer as mobile indicated by the reference of 409. As the consumer 409 moves through different means, e.g., driving, a mobile-enabled device 410 transmits geographical coordinates to the Data Server 422. For example, the GPS coordinates of the current location X,Y 413 of the consumer 409 along with other account information can be transmitted by the consumer device 410. This information is transmitted through a reliable communication method, e.g., TCP/IP through the mobile communication link 415, received by a mobile communication tower 417 and then via network 420 to the Data Server 422. It can be appreciated that the consumer device 410 can make use of other types of communication networks, e.g., Satellite network, etc. to transmit its GPS coordinates. The Data Server 422 looks up in the database against the unique consumer's accounting information and determines which items consumer 409 is interested in. Based on the consumer's current location, as recognized by the Data Server 422 through the GPS coordinates X,Y, 413, the Data Server 422 searches all the stores with their GPS locations already known to the Data Server 422. It looks at the items the consumer is interested in, with the buying criteria, and compares it to the items available at the stores. It also ensures that the store locations are within a desired distance range of the current consumer location or default location.

To illustrate this with an example, suppose the consumer 409 has expressed interest in Blue Jeans with a price range and other buying criteria, e.g., brand name, color, size, warranty, return policy, etc. As the consumer 409 “beacons,” with the consumer device 410, GPS coordinates X,Y, 413 to the Data Server 422, the Data Server searches its database and finds that for instance Macy's (a Departmental Store) carries the consumer specific item, Blue Jeans, and has them in stock. The Data Server 422 further matches the consumer's buying criteria with the item's particular selling characteristics. It further calculates the distance between particular Macy's store locations based on geographical parameters e.g., GPS coordinates, and the current consumer 409 location. If the distance falls within the range of the consumer's buying criteria for this purchase, a notification is sent to the consumer 409 in one of several ways, e.g., an html enabled multimedia message, a text message, a voice call, or a voice mail, etc. In addition to the specified item (e.g., blue jeans), if the Data Server 422 determines that “Macy's” 400 carries any previously specified consumer 409 items of interests and the distance along with any other characteristics of the consumer 409 specific items falls within consumer 409 acceptance criteria, it sends out a message to the consumer 409 about the availability of the additional items along with the characteristics of those items. The Data Servers 422 send a message through one or multiple formats to the consumer 409 about the availability of the consumer requested items. The message can be sent in different formats such as a webpage, text message, email, voice call, voice mail, voice beep tone or in any combination.

For example, the consumer 409 has shown interest in buying a pair of blue jeans and has registered the item as an item of interest with the Data Server 422. As the consumer's current location coordinates X,Y, 413 are transmitted to the Data Server 422, the Data Server searches its database and determines that there is a Macy's store 400 which carries the pair of blue jeans on sale and is located at geographical coordinates U,V 401 which is within range of the consumer's specified distance as determined by the consumer's current geographical coordinates, X,Y 413. The Data Server 422 also matches with any of the consumer 409 additional requirements or preferences. If all of the consumer's requirements are met then the Data Server 422 sends message in one or more formats to the consumer 409 informing the consumer 409 of a match. Some of these message formats are illustrated in FIG. 4. In addition, these message formats can be one or a combination of multiple formats. Some of these message formats can be a JAVA and/or HTML web enabled messages. The message can carry multimedia (text, voice and video) information in it. The message can consist of receiving a phone call from a consumer representative or receiving a voicemail.

As another example, a consumer can use another embodiment of the presented method and system to conveniently find a place for a meal based on price, food type preference, location, time of the day and/or any other criteria that a consumer would like to utilize. As an example, the consumer 411 sets his/her preferences for eating lunch based on price, food type, specific days, time of the day, etc under his account in the Data Server 422. As explained before, the consumer 411 can access his account in the Data Server 422 through multiple methods. For example, the consumer 411 can enter his/her preferred criteria into the Data Server 422 through an enabled networking device, through a consumer service representative or by any other means. As the consumer 411 drives his/her location parameters, e.g., GPS coordinates, X,Y, 413 are transmitted to the Data Server 422. The Data Server looks at the consumer 409 account and determines which food items, food types, the consumer 411 would be interested in while currently located at a particular location at X,Y coordinates. The Data Server determines that the consumer 411 has setup a time between 12:00 to 1:00 pm as lunch time. The Data server 422 checks the current time, if the current time is within the consumer specific time interval, the Data Server matches the consumer 409 preferences with the next criteria. If the consumer has setup a price range for a specific food then Data Server 422 searches for all the matching criteria restaurants. For example, in this case if the restaurant 403 happens to match with the consumer's defined criteria the GPS coordinates of the restaurant 403 will be transmitted to the consumer's device 410 which can guide the consumer to the restaurant 403. As mentioned earlier, the Data Server 422 can engage other methods to inform the consumer 411 about restaurant 403.

In a similar manner, a house 406 which is on sale sends its GPS coordinates with all the criteria that the seller wants, e.g., selling price, discount, credit requirements, income requirements, etc. to the Data Server 422. The consumer 411 is also searching for the house. As the Data Server 422 determines that the consumer 411 current coordinates are within a specific range of the house 406, it also matches the consumer's 411 buying criteria with the house's 406 selling criteria. If the criterion is successful, the Data Server 422 transmits a message in one or multiple formats to consumer 411. For example, it can send a complete HTML or JAVA based message to the consumer's device 410 informing the consumer about all the details of the house 406.

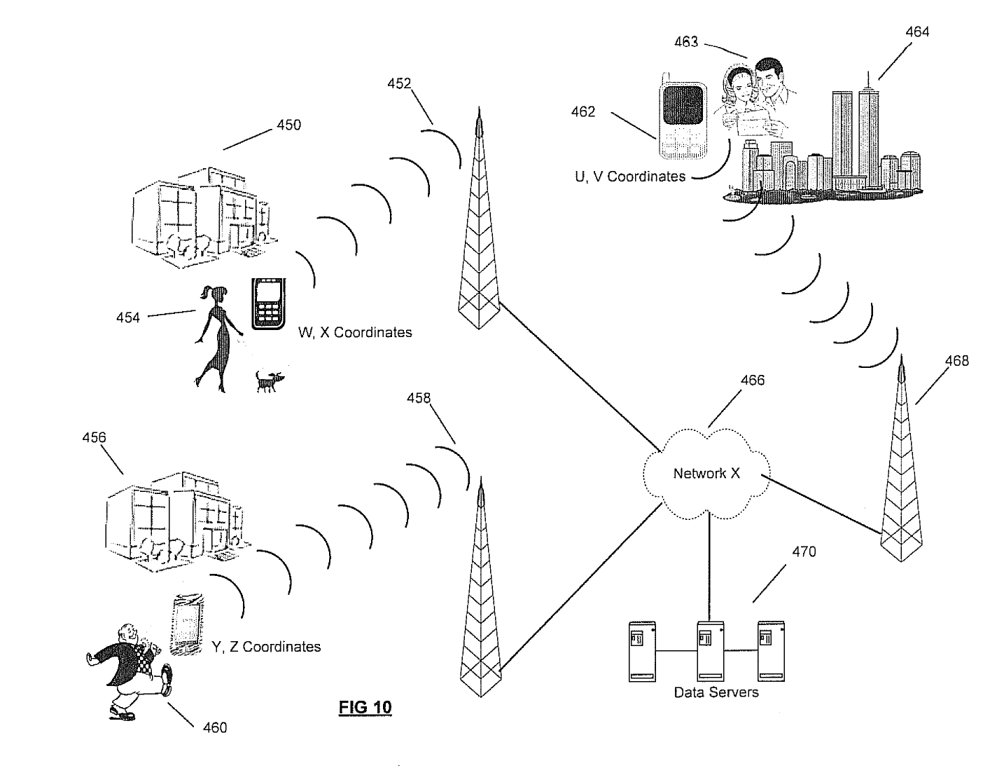

FIG. 10 illustrates the concept of mobile “twitter”. People can enroll with the Data Server and pick other people with whom they would like to keep in touch. For example, people who are part of a social network or family or friends can define criteria such that if their GPS coordinates are within a certain geographical distance then they should receive some type of alert. For example, the consumer 460 has enrolled himself to be in a network with another consumer 454. In addition, the consumer 460 has defined the additional criteria for interacting with the consumer 454. For example, this criterion can be based on distance, time of the day, social ranking that either consumer can define, consumer's 460 other priorities that can dynamically change the ranking as how the consumer 454 could interact with 460. Both consumers 454 and 460 transmit GPS-enabled geographical coordinates to the Data Server 470. It should be noticed that GPS coordinates is one type of geographical coordinates. There could be other types of coordinates. These coordinates are transmitted to the Data Server through small data packets. For example, the data packet can consist of a UDP/IP format where the payload carries the values of the GPS coordinates. As these packets are received by the Data Server 470, the Data Server accesses both consumers' accounts and process the matching criteria entered by each of the consumer. If the matching criterion matches, it sends either one consumer or both consumers the GPS coordinates of the other. In addition, it can utilize other methods to inform the consumers 454 and 460 about their close proximity. For example, a simple text message, a phone call, a voice mail, etc. After receiving the information both consumers can decide if they would like to socialize or not with the other person. The frequency of beaconing the transmission of the GPS coordinates can be dynamic and it can be interlinked to different criterion. For example, the distance between the two or more consumers, their social preferences, etc.

In a similar manner, a consumer 463 living in a remote city 464 can send their GPS coordinates, U,V through the device 462 less frequently if consumer 460 is the only other one in their social network. It is less likely that consumers 463 and 460, living a significantly far distance apart, will have a high probability of frequently physically meeting.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for providing targeted information, comprising:
receiving data comprising at least one of a consumer's product or service interests;
inspecting the data to determine at least one consumer product or service interest;
comparing the determined at least one product or service interest with a plurality of providers of products or services; and
conveying information related to at least one of the plurality of providers of products or services to the consumer based upon the comparison of the determined at least one product or service interest and the plurality of providers of products or services.

2. The method for providing targeted information of claim 1, wherein the data is stored and retrieved from a database.

3. The method for providing targeted information of claim 1, wherein the data comprises at least one of websites visited by the consumer, details of products purchased by the consumer, and details of services purchased by the consumer.

4. The method for providing targeted information of claim 1, wherein the conveyed information comprises at least one of advertisements in websites, delivered email, a text message, voice call, materials sent by a postal service, radio transmission, and any combination.

5. The method for providing targeted information of claim 4, wherein the conveyed information comprises audio, video, audio/video, still photography, and any combination.

6. The method for providing targeted information of claim 4, wherein the advertisements in websites are advertisements that the consumer may view or read at a future date, and wherein the advertisements in websites are based upon past website visits.

7. The method for providing targeted information of claim 1, further comprising:
receiving the consumer's geographical location;
receiving geographical locations of at least one of the plurality of providers of products or services; and
conveying information related to at least one of the plurality of providers of products or services to the consumer based upon the comparison of the determined at least one product or service interest and the plurality of providers of products or services, wherein the geographical location of the at least one of the plurality of providers of products or services is within a selected distance from the consumer's geographical location.

8. The method for providing targeted information of claim 7, wherein the at least one of the plurality of providers of products or services that has a geographical location within the selected distance from the consumer's geographical location also has the desired product or service.

9. A computer readable media comprising computer-executable instructions stored therein, the computer-executable instructions comprising:
instructions to receive data comprising at least one of a consumer's product or service interests;
instructions to inspect the data to determine at least one consumer product or service interest;
instructions to compare the determined at least one product or service interest with a plurality of providers of products or services; and
instructions to convey information related to at least one of the plurality of providers of products or services to the consumer based upon the comparison of the determined at least one product or service interest and the plurality of providers of products or services.

10. The method for providing targeted information of claim 9, wherein the data is stored and retrieved from a database.

11. The method for providing targeted information of claim 9, wherein the data comprises at least one of websites visited by the consumer, details of products purchased by the consumer, and details of services purchased by the consumer.

12. The method for providing targeted information of claim 9, wherein the conveyed information comprises at least one of advertisements in websites, delivered email, a text message, voice call, materials sent by a postal service, radio transmission, and any combination.

13. The method for providing targeted information of claim 12, wherein the conveyed information comprises audio, video, audio/video, still photography, and any combination.

14. The method for providing targeted information of claim 12, wherein the advertisements in websites are advertisements that the consumer may view or read at a future date, and wherein the advertisements in websites are based upon past website visits.

15. The method for providing targeted information of claim 9, further comprising:
instructions to receive the consumer's geographical location;
instructions to receive geographical locations of at least one of the plurality of providers of products or services; and
instructions to convey information related to at least one of the plurality of providers of products or services to the consumer based upon the comparison of the determined at least one product or service interest and the plurality of providers of products or services, wherein the geographical location of the at least one of the plurality of providers of products or services is within a selected distance from the consumer's geographical location.

16. The method for providing targeted information of claim 15, wherein the at least one of the plurality of providers of products or services that has a geographical location within the selected distance from the consumer's geographical location also has the desired product or service.

17. A method for providing targeted information, comprising:
determining a consumer's geographical location;
reviewing a products and services criteria for the consumer to determine providers of products or services that meet the products and services criteria and are within a selected distance from the consumer's geographical location, wherein the products and services criteria comprise products or services the consumer has an interest in;
conveying information related to at least one provider of a product or service to the consumer when the selected provider is within the selected distance from the consumer's geographical location and within the products and services criteria.

18. The method for providing targeted information of claim 17, wherein the products and services criteria comprises at least one of specific product interests, maximum price requirements for particular products and services, day and time criteria, and specific service interests.

19. The method for providing targeted information of claim 18, wherein the specific product interests comprise a type of product, wherein a type of product comprises houses for sale that meet the maximum price requirements for homes for sale, the day and time criteria, and other product criteria for houses for sale.

20. The method for providing targeted information of claim 18, wherein the specific service interests comprise a type of service, wherein a type of service comprises restaurants that meet the maximum price requirements for restaurants, the day and time criteria, and other service criteria for restaurants.

21. The method for providing targeted information of claim 19, wherein a type of product comprises any product that the consumer desires to purchase.

22. The method for providing targeted information of claim 20, wherein a type of service comprises any service that the consumer desires to purchase.
